(19) United States
(12) Patent Application Publication
(10) Pub. No.: US 2022/0256231 A1
(43) Pub. Date: Aug. 11, 2022

(54) SYSTEMS AND METHODS FOR SYNCHRONIZING DATA STREAMS

(71) Applicant: HAPPANING LTD, London (GB)

(72) Inventor: Andrew Eniwumide, London (GB)

(73) Assignees: HAPPANING LTD, London (GB); HAPPANING LTD, London (GB)

(21) Appl. No.: 17/619,181

(22) PCT Filed: Jun. 11, 2020
(86) PCT No.: PCT/GB2020/051404

§ 371 Date: Dec. 14, 2021

(30) Foreign Application Priority Data
Jun. 14, 2019 (GB) 1908567.9

(51) Int. Cl. H04N 21/43; H04L 65/60; H04N 21/218; H04N 21/458; H04N 21/472; H04N 21/439

(52) U.S. Cl. CPC H04N 21/43072; H04L 65/60; H04N 21/4394; H04N 21/458; H04N 21/472; H04N 21/21805

(57) ABSTRACT

A system and method for synchronizing data streams, enabling viewers to view and/or switch between multiple vantage points of an event in real time and/or retrospectively.

### CROSS-REFERENCE TO RELATED APPLICATIONS

This application is a national phase entry under 35 U.S.C. § 371 of International Patent Application PCT/GB2020/051404, filed Jun. 11, 2020, designating the United States of America and published as International Patent Publication WO 2020/249948 A1 on Dec. 17, 2020, which claims the benefit under Article 8 of the Patent Cooperation Treaty to Great Britain Patent Application Serial No. 1908567.9, filed Jun. 14, 2019.

### TECHNICAL FIELD

This disclosure relates to systems and methods for synchronizing data streams, enabling viewers to view and/or switch between multiple vantage points of an event in real time and/or retrospectively.

### BACKGROUND

Many events such as concerts, speeches and sports matches are captured on video by multiple users. Footage from events may be available from official sources and/or from individuals sharing their own footage during or after an event. As video capture is becoming ever more popular, more and more users record live events and share their videos for others to view. However, a viewer is only able to view video segments uploaded onto a video sharing site such as YouTuBE®, which only provide a single field of view or vantage point.

Multi-vantage point systems may allow users to view multiple video streams in a sequential manner or alternatively present numerous predetermined vantage points, but only in a preformatted view. Furthermore, user videos can be extremely variable in quality and there is no reliable way of assessing their quality before watching.

The present disclosure provides a system and computer-implemented method for synchronizing data streams, enabling viewers to view and switch between multiple vantage points of an event in real time or retrospectively.

### BRIEF SUMMARY

The present disclosure provides methods and systems for synchronizing multimedia data “feeds” or streams and provides a multi-vantage multimedia data stream and media format (a ViiVid ®).

Multiple data streams may be received from multiple devices across a network and synchronized so that a user may view multimedia data (images, audio and video) from multiple vantage points. In some embodiments, a user may view multiple data streams at once on a multi-view interface, view an event choosing between vantage points, or view an event where the vantage points change dynamically depending on the parameters of the streams.

The data streams are generated by networks of mobile and static recording devices that transmit and detect (e.g., by scanning at regular intervals) beacon signals to identify other devices within a predetermined range. The data streams, which may include audio/video output, time signatures, location and position (device orientation and heading/facing (compass direction)) information, may be broadcast to peers within a network. Simultaneously, data streams from other peer networks also become available to receive and process in real time.

The data streams are synchronized by time and location-based data, allowing users to interactively pan in a given direction between vantage points in real time and/or retrospectively in a synchronized manner. In some embodiments, markers may be overlaid (e.g., rendered in AR, or embedded in the synchronized data stream) to indicate the relative location and position (distance, altitude and/or direction) of other available vantage points within the current field of view, while edge markers may indicate the relative position of other vantages currently out of frame.

In some embodiments, real-time client-side processing and data transmission enables wireless vantage point navigation via a mobile or web-based client. Server-side data stream uploads and processing may enable live streaming outside of the network and retrospective vantage point navigation via web and/or mobile clients. A centralized web client may also be embedded into third-party websites and/or applications providing the same interactive video navigation functionality on those target platforms.

In some embodiments, Augment Reality (AR) is used to plot/render the relative location and position (distance, altitude and/or direction) of other potentially moving vantages over the playback, allowing users to move in a desired direction relative to what they are seeing.

In some embodiments, user controls, swipe or motion gestures may be employed to determine the direction of travel for the viewer or to navigate from one vantage point to another, enabling the user to view the camera output (which in itself may be 2-or 3-dimensional, e.g., 360°) from another video feed. The user may be able to preview or switch from one vantage point to another by selecting markers on the controller view (e.g., an interactive map view or carousel) or gesturing on the camera view in an intended direction.

The present disclosure demonstrates numerous benefits:

Immersion: As well as having control over which perspectives they view, users have a greater appreciation of the space being viewed and the relative distances between vantage points. The user experience is further enhanced with full AR/VR compatibility, intuitive controls and dynamic interactions.

Efficiency: The networked system performs de-duplication, redundancy checks and reduces unnecessary processing, thus the networked system as a whole is vastly more efficient.

Accessibility: Anybody can record and explore vantages, live or retrospectively (using the most widely available equipment or higher quality professional broadcasting rigs, HD and 360° cameras) without having to predetermine the vantage point locations and headings. Cloud computing implementation means advance processing techniques and content can be deployed anywhere with an active internet connection.

Flexibility: Users can record their own perspective while viewing other streams (vantages) simultaneously. Users can use the technology to view alternative vantages anywhere and anytime, with or without an internet connection.

Accuracy: The system/method can account for moving vantage points during the recording within a greater degree of location accuracy than GPS. The processing delivers greater timing synchronization accuracy, which is not predicated on device-based time syncing alone.

Extensibility and Resilience: A decentralized recording network means the system can leverage many more vantages live and that there are no single points of failure in the network as the peer connection management optimizes feed performance regardless of hardware limitations. Users can retrospectively append and synchronize more vantages, including ones taken outside of the platform using retrospective merges.

Veracity: By enabling multiple viewpoints in a peer-verified network, ViiVids serve also to establish the truth of an event, by allowing the viewer to navigate any of the synchronized vantages at will, corroborating the various accounts as they would with witness statements.

Media Format: ViiVids are a fully exportable media format that can be replayed retrospectively, whether on or offline on cross platform media players, which in themselves may comprise embedded plugins and or API implementations. Provided there is sufficient data to correlate them in time and space, ViiVids can be merged innately so as to increase the number of vantages of a given event.

Moreover, the claimed system and method operates effectively irrespective of the specific data being processed. The data processing can be performed in substantially real time, where peer devices exchange data whilst recording the data stream to establish parameters and ease synchronizing of the data streams. In some embodiments, low performance devices may offload local processing to higher specification devices, which may be other recording devices and/or include server devices. This data exchange shifts data processing to enhance overall efficiency, reduce delays and enable real-time sharing and consolidation to generate a multi-vantage data stream, providing a much more immersive experience for the end user.

The present disclosure provides methods, devices, computer-readable media and computer-readable file and media formats as outlined below, as recited in the non-limiting examples and as claimed.

### BRIEF DESCRIPTION OF THE DRAWINGS

In order that the present disclosure may be more readily understood, preferable embodiments thereof will now be described, by way of example only, with reference to the accompanying drawings, in which:

FIG. 1 is a block diagram illustrating a birds-eye view of an event being captured by recording devices;

FIG. 2 is another block diagram illustrating a birds-eye view of an event being captured by recording devices and data being exchanged with a server and a viewer device;

FIGS. 3A and 3B are block diagrams illustrating a) a birds-eye view of an event being captured by recording devices at various vantage points 1-4 and b) showing the camera views at the vantage points 1-4;

FIGS. 4 and 5 are block diagrams showing the various devices in a wider recording and content delivery network (CDN);

FIG. 6 is a flow chart showing the management of event identifiers (eventIDs) and network peers;

FIG. 7 is a flow chart showing the post-production processing flow; and

FIG. 8 is a flow chart showing data flow between various wider-system components.

### GLOSSARY OF TERMS

Heartbeat—a periodic signal generated by hardware or software to indicate normal operation or to synchronize parts of a computer system.

Handshake—The initial communication sequence that occurs when two devices first make contact.

Media artefact—A digital media file such as a video file, an audio track, an image file, etc.

Timeline artefact—A digital file containing sequential event data detailing pertinent activity while a recording is made (discussed further below under Timeline and timeline messages).

### DETAILED DESCRIPTION

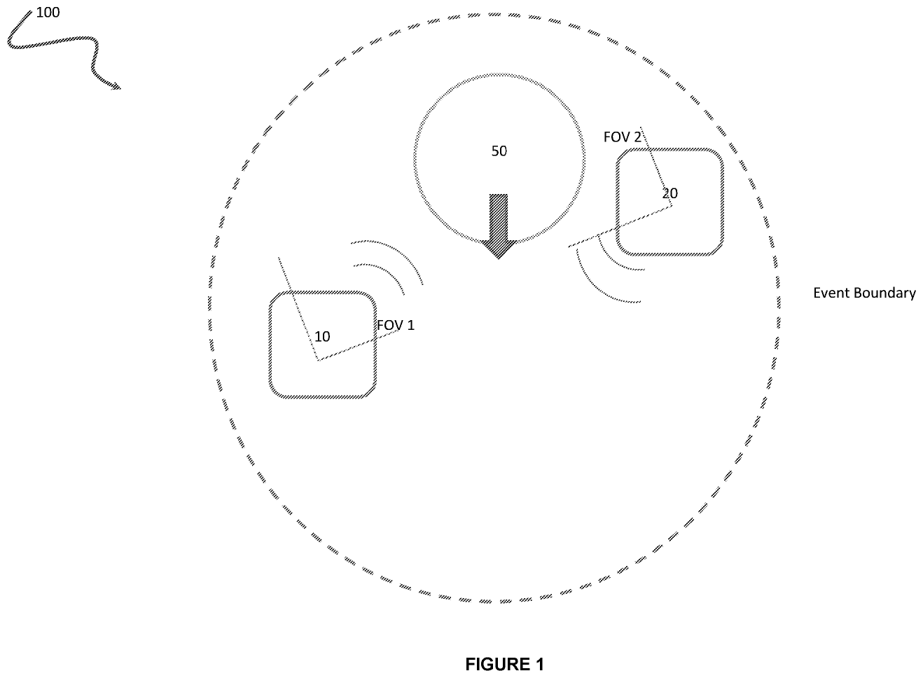

FIG. 1 illustrates a first simple embodiment of the disclosure. The system 100 comprises a first recording device 10 at a first vantage point having a first field of view (FOV) of a subject 50, recording a first live video data stream 11. The first vantage point has a location in 3D space and a position (orientation and heading). The first recording device 10 advertises the first generated data stream 11 on a network, which may comprise, e.g., BLUETOOTH®, WI-FI® and/or cellular networks. A second recording device 20 at a second vantage point has a second field of view of the subject 50 and is recording a live video data stream 12. The second vantage point has a second location and position. The second recording device 20 advertises the second generated data stream 12 on the network. The second recording device 20 can see the advertised first stream and exchanges data with the first device 10 over the network, maintaining a status of the data streams on the network, for synchronizing the streams.

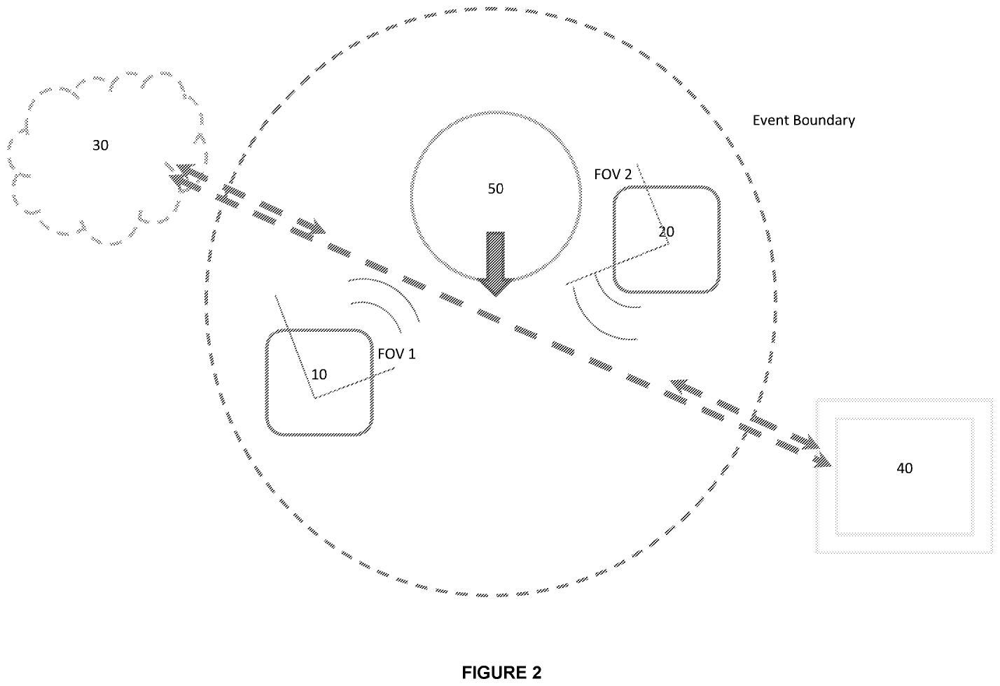

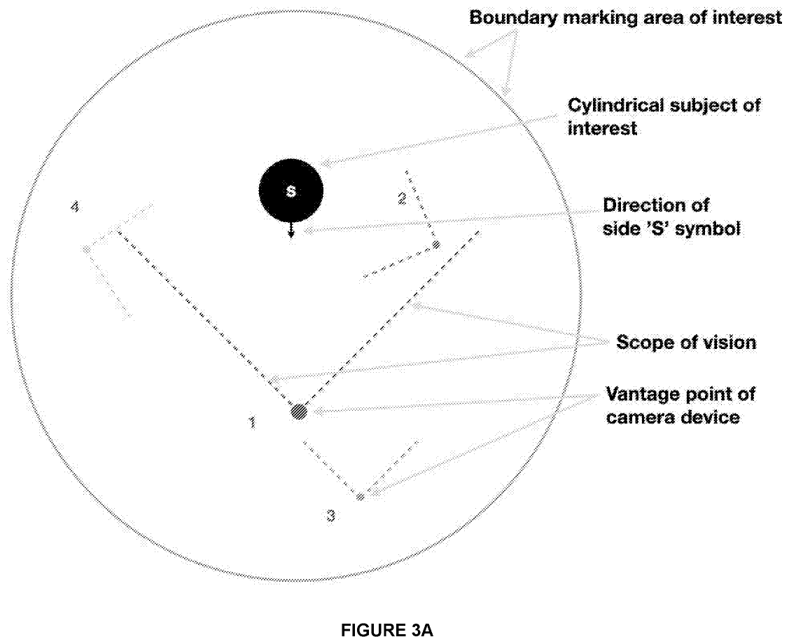

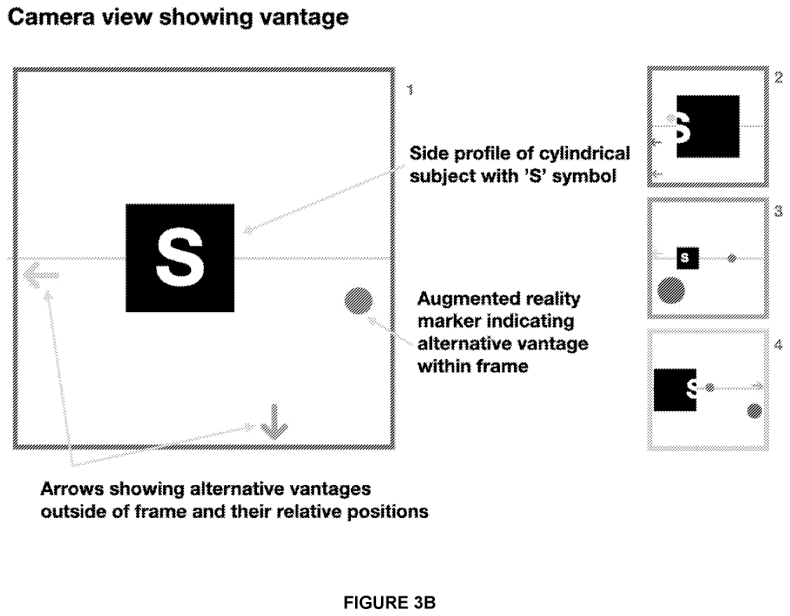

In some embodiments, the data streams are synchronized over the network by data exchange for delivery to a viewer device, which may be one of the original recording devices 10, 20, or a third device. In some embodiments, the recording devices or a server consolidates (multiplexes) the streams for delivery to other devices, discussed further with reference to FIG. 2 below.

The data stream has various data stream parameters that may include:
user parameters such as user identifiers, user profile data, user cellular data limits and user preferences, etc.;
device parameters such as device identifiers (MAC address, UUID), OS information, device performance characteristics (e.g., processor, memory, storage and network performance specifications), device processor, memory and storage utilization, device temperature, device battery level, device location in space, device position (comprising orientation (including portrait/landscape) and heading/facing (compass direction)), network peers, active camera information, etc.; and
recording/media parameters such as stream identifiers, event identifiers, image data, audio data, object data, peer messages/instructions, bitrate, resolution, file format, secondary relay data, start time, field of view and metadata, etc.
   Secondary relay data refers to data relayed from one peer device to another peer device, via a series of other peers. Essentially, a device that receives this type of data (where it is not the desired destination) is being used as a network router and will relay that data to the desired destination using a routing protocol such as OSPF (Open Shortest Path First), or similar IGPs (interior gateway protocols). Some embodiments utilize the OSPF protocol to provide a more efficient data transfer, reducing latency and power consumption.

Data is preferably exchanged between the devices in real-time to maintain a current status of the streams and/or the devices across the network. In some embodiments, the bonjour protocol may be used. Preferably, the devices scan surrounding networks including those currently joined and others that might be available, but not necessarily “joined,” to identify other streams being advertised by other devices. Preferably scanning or polling for other devices or streams is performed at regular intervals or continuously and these devices and their streams are added to the network pool.

In some embodiments, the method further comprises displaying/rendering the synchronized first and second data streams on the first and/or second devices, supplementing the view currently being recorded. In some embodiments, the method further comprises sending the first and/or second data stream to a user, preferably indicating the available data streams to the user for selection, and/or displaying/rendering the data stream(s) on a device.

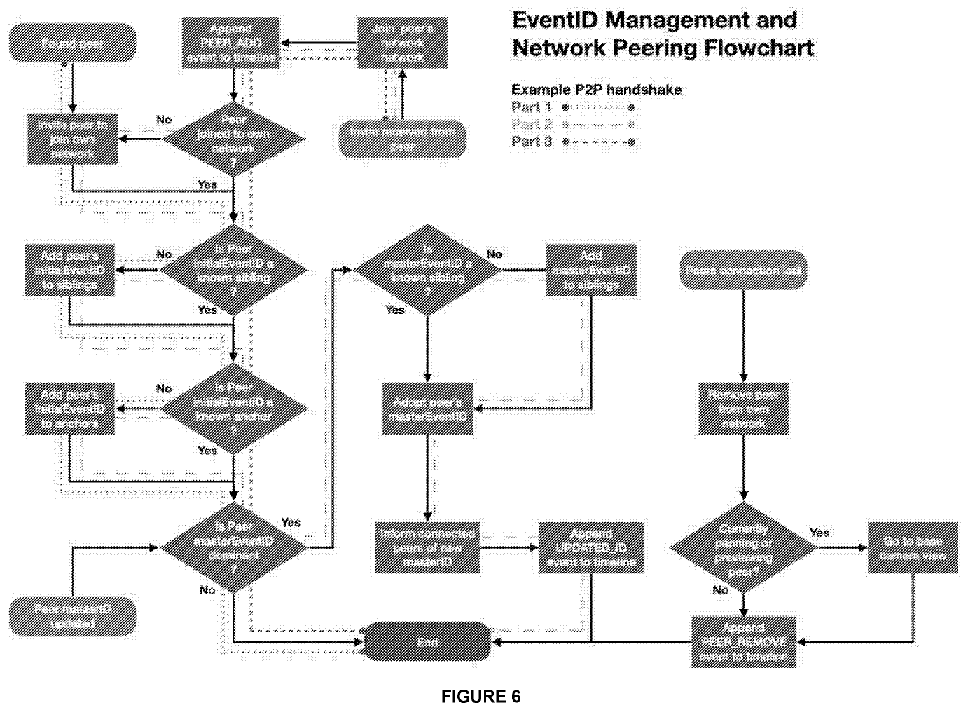

Preferably, the data exchange involves assigning and exchanging a stream identifier to uniquely identify that stream or vantage. The identifier may be assigned based on a video start time, device ID (e.g., UUID), device location and/or device position. Preferably, a composition comprising the datetime (to the millisecond) and the unique device ID is used, as this cannot be easily replicated. Preferably, the identifier comprises an initialEventID and a masterEventID and the method comprises comparing and updating the initial and master EventIDs. This process is discussed in more detail with reference to FIG. 6 below.

The data exchange may also comprise sending and/or receiving P2P handshakes, Network Time Protocol (NTP) data, timing heartbeats and parameters of the data stream(s) to synchronize the streams, preferably in real time. In some embodiments, the data exchange is continuous, but in others is a differential exchange, only sending/receiving information when there are changes, for efficiency.

FIG. 2 illustrates a second embodiment of the disclosure, building on the system of FIG. 1. Here, a compute node or server 30 is provided as a central communications hub for the system 100, which can reduce load on the network and provide a central storage for data. The server 30 may also perform server-side processing to optimize the data streams or parameters of the user devices to optimize the system, preferably in real time, e.g.:
adjusting a bitrate of the data stream(s) being received and/or sent to other devices, depending on the connection speed and/or latency;
transcoding data stream(s) for delivery to other devices;
weighting or ranking data streams, e.g., based on their data streams parameters, proximity to an event and/or user feedback;
tracking the availability, parameters and/or status of the data streams (e.g., timing, location and position of the data streams and whether the data stream is still live or not) e.g., using a database, preferably in real time;
combining the data streams with additional data from other resources, such as stock or pre-recorded footage or live footage from external sources; and/or
storing live streams as and/or complete streams after recording finishes.

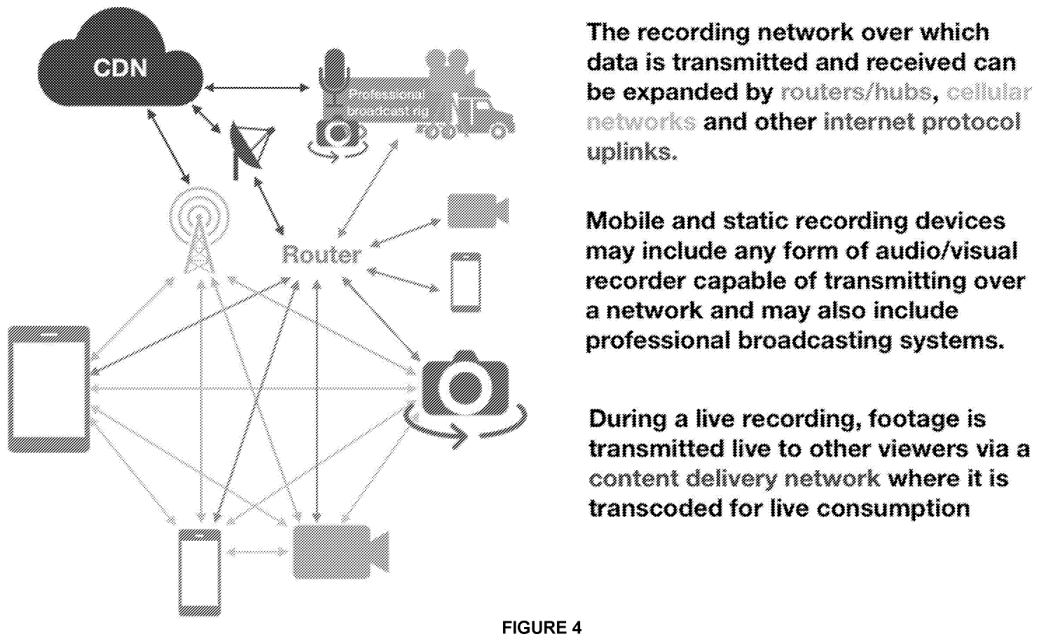

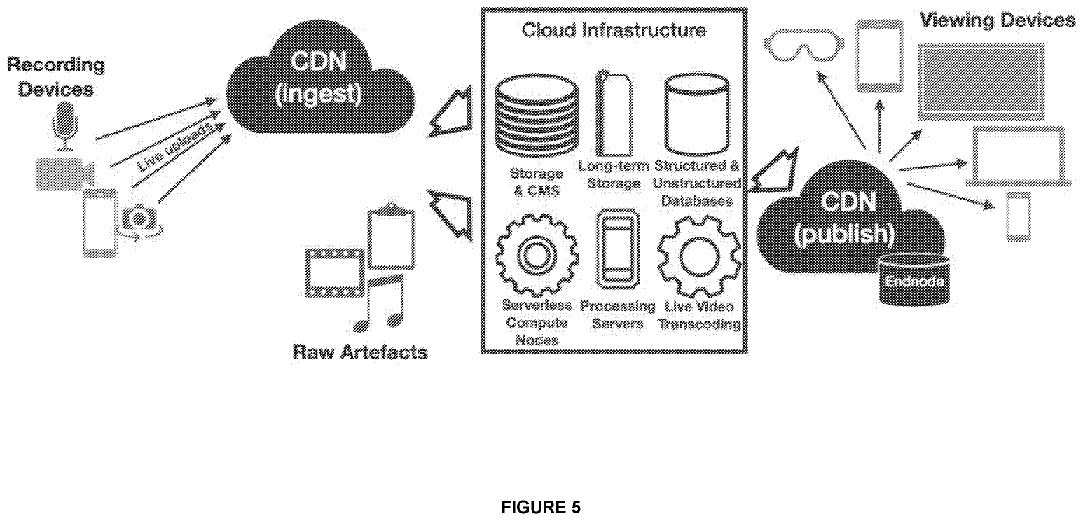

In other embodiments, some or all of the above processing may be performed on the local devices or be distributed across a combination of peer devices and network compute nodes or servers. FIGS. 4 and 5 illustrate the various devices that may be used in a wider recording and content delivery network (CDN).

Preferably, the system 100 monitors the entire network of devices including the user devices 10, 20 (and so on as applicable) and the server 30 if present, and distributes the processing depending on the data stream parameters, particularly user and device parameters such as cellular data limits, device performance characteristics and utilization, device temperature and device battery level. Preferably this network monitoring is performed at regular intervals, e.g., every 1-10 seconds, every 30 seconds or every 1-5 minutes, but more preferably operates substantially in real-time. This network monitoring maximizes efficiency since the system can utilize devices having the most efficient processors with sufficient capacity and network capabilities where conditions allow, e.g., utilizing the most powerful processors of devices where their battery level, processor/memory/storage utilization and operating temperature parameters are within predefined limits and transferring the data processing steps to maintain the optimum. If a particular device has, e.g., a low battery level or a capped data plan approaching its limit, then corresponding transcoding or cellular data transfer tasks can be reallocated dynamically as appropriate. This arrangement provides a further improved networked system, running more efficiently and effectively as a computer system and reducing power consumption.

The server 30 may also perform additional audio and/or visual processing as discussed further below.

In the embodiment of FIG. 2, a viewer device 40 is also provided for receiving and displaying the data streams. The viewer device may be in the form of a mobile telephone, a computer or a VR headset, for example. In preferred embodiments, the viewer device 40 receives the data streams and displays them to a user. If the viewer device 40 is also a recording device then the streams may be synchronized and consolidated locally on the viewer device, or by other devices in the network via P2P, or a single device such as the server 30.

Preferably, the available vantage points for the stream are indicated to the user and are user-selectable. The vantage points may be mapped on an onscreen or AR map and controls may be provided or gesture inputs received from the user and processed for navigating between vantage points. Preferably, transitions between vantage points are animated.

In this embodiment scenario, the first recording device 10 has assigned an initialEventID, detects the second recording device's advertisement of stream 12 and performs a peer-to-peer (P2P) handshake such that a two-way connection is established.

As part of this handshake, the second device 20 adopts first device 10's initialEventID as its own masterEventID and an anchor, while the first device 10 acknowledges the second device 20 as a sibling and anchor.

In this embodiment, the second device 20 is physically located within first device 10's field of vision and appears as an AR marker in the first device 10's camera view. The first device 10, being outside of second device 20's field of vision, is represented as an edge marker in the periphery of the second device 20's camera view.

The second device 20 receives user input to navigate to the first device 10's vantage point and so the first device 10's stream 11 is retrieved over the network and displayed on the second device 20's camera view, e.g., with second device 20's own camera view being presented in a miniature view overlaid on top. The second device 20 can now see the first device 10's perspective.

If the first device 10 receives user input to preview the second device 20's perspective, then similarly a miniature view of the second device 20's data stream 12 may be overlaid on the first device 10's camera view.

If the first device 10 concludes its recording, terminates the first stream 11 and closes its connection to the second device 20, then the second device 20 detects the termination of the first stream 11 and automatically navigates back to its base camera view. If another vantage more closely aligned with the first stream 11 was available, the second device 20 may navigate to that vantage point instead of its base camera view upon the termination of the first stream 11, depending on what was deemed least interruptive to the viewing experience. Following this, the first device 10 automatically uploads a locally-generated video capture at the earliest opportunity to the network (e.g., to the server 30, or to a shared storage) with an associated timeline artefact for post-production processing. Should any other devices join the same recording network at this stage, they will adopt the first device 10's initialEventID from the second device 20 as their masterEventID, due to the P2P handshake.

The second device 20 concludes its recording and as such, terminates the stream 12. The second device 20 then also automatically uploads to the network a locally generated video capture with an associated timeline artefact for post-production processing.

The user of viewer device 40 wants to view the event, so streams the media to a compatible player and watches the event from the pre-recorded perspective of the first device 10. During playback, a marker for the vantage point of the second device 20 appears in the video frame indicating the position of the second device 20's vantage point relative to the current (the first device 10's) field of vision.

The user of viewer device 40, having realized that the second device 20's vantage is closer to the subject, decides to switch to the second device 20's view and so using the user controls, initiates the switch. The user of viewer device 40 navigates to second device 20's position to view the rest of the event from the second device 20's perspective. The first device 10, being outside of the second device 20's field of vision, is now represented as an edge marker in the periphery of the current footage being view by the viewer device 40.

Shortly after, the edge marker disappears, indicating that first device 10's footage has concluded. Shortly thereafter the footage concludes.

In some embodiments, the devices each detect other streams joining the network (e.g., by MAC address, UUID, etc.) and monitor and send and/or receive data relating to changes to data stream parameters and location and/or position data of each stream. This enables the devices to react in real-time to other data streams, e.g., detecting duplication. If a first mobile device is adjacent to a static recording device, both of which are recording and uploading a data stream to a network, the streams can be compared and then the upload streams adjusted. For example, if the fields of view of two streams overlap then this can be detected and differential uploading could be used for the lower quality or lower bandwidth stream. If a data stream is entirely redundant then its upload could be disabled entirely. This real-time analysis of data streams promotes power efficiency since redundant streams are not uploaded and differential uploads can be utilized. However, if location and/or position data are also exchanged between devices and a device moves and starts to provide a fresh field of view, then this is identified and uploading may continue.

Consolidated data stream

In some embodiments, the method comprises synchronizing and combining the data streams into a consolidated data stream, preferably substantially in real time.

In one form, the consolidated data stream comprises a multi-vantage-point media format comprising multiple audio and/or visual feeds synchronized by time and location-based data, allowing users to interactively pan between vantage points in real time and/or retrospectively. The media format may be delivered as a video where the user may choose a vantage point, or delivered as part of a VR or AR system, where markers may be overlaid to indicate the relative position of other available vantage points within the current camera shot's field of vision, while edge markers may indicate the relative position of other vantages currently out of frame.

In some embodiments, the consolidated data stream comprises a multi-vantage-point video comprising alternative primary and secondary video footage of an event from multiple different vantage points and the vantage point for at least a portion of the video is user-selectable. If the video is considered to have a single “master timeline,” then the user may be able to select between the primary and secondary (and beyond) footage from alternative recording devices at different vantage points at various points in the timeline; and/or view footage from multiple vantage points at the same time with a multi-view setup. Selecting between the primary and secondary footage substitutes the primary video feed for the secondary feed or vice versa. In other embodiments, the video footage changes dynamically depending on parameters of the data stream or user, e.g., changing in response to the number of users streaming a feed, a demographic of those users, a weighting or ranking of a feed, and/or user preferences.

In some embodiments, the consolidated data stream comprises a multi-vantage-point video comprising video frames stitched from image or video frames from multiple vantage points and/or audio stitched from multiple different vantage points. For example, two vantage points might be offset at a known angle, say 30° from a subject, and spaced apart by 5 m. The fields of view of these streams can be combined frame-by-frame to form a single consolidated stream with a wide-angle field of view. If there are anomalies or obstacles in the data stream then additional image or video footage could be substituted or combined. Similarly, if the recording devices only record mono audio then the audio streams may also be combined to provide a stereo audio track. Alternatively, the data streams may be analyzed for duplication and redundant data removed or substituted for audio data of higher quality.

In some embodiments, additional visual or audio processing may be performed to the consolidated data stream. The method may involve analyzing the data streams for duplicate audio content and editing the consolidated data stream to provide a single audio track for the consolidated data stream, e.g., by ranking the streams by quality (bitrate, clarity, relative location—e.g., near or far from event), weighting and selecting the single highest quality stream, or merging streams to establish a consolidated stream—e.g., merging left and right mono audio streams to provide a stereo stream; or merging multiple positional sources to provide a surround stream, etc. In some embodiments, 3D audio content may be derived from the streams, preferably taking into account the vantage's heading and/or the viewer's heading transitions in 360° panoramic implementations, e.g., by using vector calculus.

Anomaly processing may also be performed, e.g., if one source has background noise then this can be detected and removed by analyzing other streams to establish a clean master audio track. Similar visual processing may be performed to remove visual anomalies such as dirt on a lens, or obstructions in the field of view, by analyzing and combining other feeds. Obstructions are a particular problem at concerts where a high percentage of attendees tend to record a performance—each user's footage shows other users in front recording the performance. The disclosure addresses this problem by synchronizing and consolidating the data feeds and can remove the obstructions using other streams that offer different fields of view and/or that provide sufficient information to modify the data stream to adjust/correct for the obstruction to remove it, enhancing the quality of the recording.

In further embodiments, additional processing may be performed to simulate a different environment or vantage point by adapting the visual and/or audio data to reproduce visual and/or audio effects from a different environment or vantage point.

Some aspects of the system are now described in more detail.

### Recording Devices

The embodiments utilize any devices and/or systems capable of capturing audio/visual data and relaying it over a network. This importantly includes smart devices such as mobile phones, tablets, webcams and wearables as well as more traditional broadcasting systems, security cameras, HD cameras, 360° panoramic cameras, directional/omni-directional audio pickups.

Preferably, when a vantage recording begins, the recording device advertises itself as an available vantage point on a self-established wireless network while simultaneously browsing the surrounding area for other vantage points currently being broadcasted. The limits of the surrounding area may be predetermined (e.g., within a set radius, area or location) or adapt dynamically to define a 3D range (volume) within which individual devices are reliably able to receive and transmit wireless signals, in their current location. A server-side connection is also attempted in order to allow for CDN (content delivery network) enabled streaming. Local media and timeline artefacts are also created, and are appended to over the duration of the capture. Such artefacts may exist wholly or partially in volatile memory as well as on disk or may write solely to volatile memory with the buffers being flushed to disk periodically. In some embodiments the memory array of the media artefacts may be fragmented across the local disk and reassembled later on processing. Local media artefacts are created and stored at optimal quality for further processing and transcoding. In some embodiments, the initial live data stream (which may have been transcoded to a lower quality stream due to bandwidth limitations) may be replaced or supplemented by the higher-quality version stored on the local device.

### Real-Time Data Transmission and Processing

Some embodiments leverage a decentralized P2P network along with cellular and WI-FI® based networks to (preferably continuously) send and receive a stream of time-based messages between recording devices.

These timeline messages may include one or more of: P2P handshakes, timing heartbeats, locations (longitude/latitude/altitude), position (orientation, heading), statuses, event IDs, image data, etc., which means devices maintain an accurate knowledge of the statuses of other vantages in the surrounding area, as and when they are updated. Heartbeat messages may be sent between devices at regular intervals, preferably in the order of seconds. This data is preferably parsed substantially in real time for the rendering of vantage point markers. Location accuracy will improve as GPS triangulation improves its accuracy, and this is already happening with the gains in recent 5G+GPS+WI-FI® technologies. The challenge of further improving POI location accuracy for retrospective ViiVid ® viewing is addressed in the server side post-processing phase described below.

TABLE 1
details some of the data feeds that may be serviced during a recording

| Type | Description | When? | Components | How? |
|---|---|---|---|---|
| On | The augmented reality view presented | At all times; either | Video: AR | AR display |
| device | on the recording or playback device. | presented in the main | | |
| screen | | content view or the mini | | |
| | | (pre) view. | | |
| Data | The audio/visual streamed to the back | When the device is | Video: Raw/AR | Data streaming protocols |
| streamed | end server via the CDN for live | recording their vantage | Audio: Highest quality | such as RTMP, Web |
| to server | transcoding, caching and relay. | and the “use 4/5G data” is | feasible | RTC, DASH, etc. |
| | | permitted. | Timeline action messages | Codecs and compression |
| | | | | algorithms may be used |
| | | | | for more secure or faster |
| | | | | transmission. |
| P2P | Peer-to-peer audio/visual stream over | When the device is | Video: AR | WI-FI ®/DirectWi-Fi/ |
| direct | a local network propagated by the | recording. | Timeline action messages | BLUETOOTH ®. |
| | devices themselves or through a local | | Messages/Instruction | Codecs and compression |
| | hub. | | | algorithms may be used |
| | | | | for more secure or faster |
| | | | | transmission. |
| P2P | Peer-to-peer still images streamed over | Sent periodically as the | Static images sent | WI-FI ®/DirectWi-Fi/ |
| snapshots | a local network propagated by the | device is recording and | periodically to local | BLUETOOTH ®. |
| | devices themselves or through a local | when triggered by user. | peers. | Codecs and compression |
| | hub. | | | algorithms may be used |
| | | | | for more secure or faster |
| | | | | transmission. |
| Local | Content recorded to local file (e.g., | Appended to as the | Video: Raw highest | Written to local files |
| Video | mp4, jpeg, mp3, etc.) then uploaded to | device is recording. | quality | (e.g., MP4) and/or saved |
| file | backend end server for further | | Stills: Image files | in volatile memory |
| | processing and merging with other | | Audio: Highest quality | buffers, compressed |
| | feeds retrospectively. Hashing | | feasible | when the asset writer |
| | algorithms (e.g., md5sum) may be | | | closes, then sent at |
| | used to verify integrity after | | | earliest opportunity to |
| | transmission. | | | server over the internet. |
| Local | Events logged to timeline file then sent | Appended to when the | Timeline action messages | Written to local files |
| Timeline | to server for further processing and | device is recording. | | (txt) and/or stored in |
| file | merging with other feeds | | | volatile memory then |
| | retrospectively. Hashing algorithms | | | sent at earliest |
| | (e.g., md5sum) may be used to verify | | | opportunity to server |
| | integrity after transmission. | | | over the internet. |

### Real-Time Vantage Panning

Users are able to capture their own perspective while viewing other vantages simultaneously on compatible devices. Real-time vantage panning and previewing can be achieved by channeling into the live video stream via the server (accessible over an internet protocol network) or directly from peers over local network protocols such as Wi-Fi Direct, WI-FI® and/or BLUETOOTH®. Users may be able to pan alternative vantages live without an internet connection if their device is within the recording network. Otherwise, those with an internet connection can also pan alternative vantages from anywhere and at any time via a content delivery network (CDN) that provides live transcoding capabilities. This improves the viewing experience by rendering at differing bitrates and resolutions depending on the viewing device.

The transmission bitrate may be increased or decreased on a per-peer connection basis, depending on the connection latency and the transmission method (cellular, satellite, fiber, WI-FI®, BLUETOOTH®, Direct Wi-Fi, etc.). The system/method may promote more reliable or faster data streams and devices, reallocating resources to provide a more efficient system—for example, if a high-resolution stream is being captured by a first device but the cellular data uplink of that device is unable to support the full resolution for upload to the cloud, the data stream can be partially or fully re-distributed over the P2P network via WI-FI® to other devices on alternative cellular networks, which can then share the upload data transmission.

Preferably, the network follows some blockchain principles in that:
i) each device on the network has access to the complete event information—no single device controls the data and each device may validate the event and/or datastream parameters of its partners directly, without any third party partner.
ii) P2P transmission—communications happen directly between peers rather than on a central server. Every device stores and shares info to any or all other devices. Due to the decentralized device connectivity, this means there are no single points of failure in the recording network and peer connection bitrate management optimizes the performance of the feed regardless of hardware and/or network limitations. The video stream may also be accompanied by timeline action messages that, when received by the client, are used to determine where to render the augmented reality points of interest. Nevertheless, a server may also be provided as a backup and/or to provide additional functions.
iii) Data Integrity—the interoperability of the recording devices means there will often be multiple corroborating accounts of a single event; e.g., a crime suspect may be able to demonstrate their presence in a particular area at a particular time by using multiple independent data sources as an alibi due to the exchange of information at that time.

In some embodiments, the system includes a gamification engine, rewarding users who produce the most popular vantages, the best visual/audio clarity, lighting, focus, etc. In some embodiments the gamification engine may allow users to share, comment, up vote and/or down vote a particular vantage or an entire ViiVid®.

### Events and EventID Management

FIG. 6 is a flow chart illustrating the management of EventIDs and how peers and identifiers are processed when being added to the network.

Preferably, individual vantages (or video, audio, pictures) maintain a reference to an initial event and 2 collections of junior events (siblings and anchors) while maintaining a “belongs to” (many to one) relationship with a unifying entity known as a master event. The initial event identifier is generated and stored into an initialEventID parameter once a vantage begins recording. All event identifiers are composed by a combination of the video's start time and the producer's unique user identifier or device ID (UUID), e.g., 20180328040351_5C33F2C5-C496-4786-8F83-ACC4CD79C640.

In some embodiments, the initialEventID that uniquely references the vantage (or AV content) being recorded and cannot be changed for the duration of the recording. The initial event identifier is also initiated as a masterEventID when a recording begins but the master can be replaced when an already initiated master event is detected in the surrounding area with an earlier time than the current master.

In some embodiments, when a peer is detected in the surrounding area while recording, the initialEventID and masterEventID parameters are exchanged and compared to the existing event identifiers. Thus every time a new peer connection is established, a set of initial and master event identifiers are broadcast and reciprocally received for comparative processing. When processing the peer's initialEventID, a check is first made to determine whether that peer's initialEventID is catalogued in both the sibling and anchor collections named, siblingEventIDs and anchorEventIDs respectively. In the case it does not exist in either collections, it is added to them such that the peer's initialEventID exists in both collections. In this way, the vantage's anchor collection retains a record of all other vantages encountered in the surrounding area while being recorded, that is, vantages that can be panned during playback.

Following this, the peer's master event identifier is compared to the existing masterEventID with the earlier one now assuming masterEventID as the dominant event identifier. Similarly to the peer's initialEventID, inferior (later) masterEventID is added to the siblingEventIDs collection if it does not already feature there but not to the anchor's collection. By imposing the adoption of earlier master event identifiers we ensure masterEventIDs remain the principal unifying entity for the multi-perspective viiVid as a whole and also that the data pertaining to inferior events are not lost but stored with the other siblings. When a device learns of a new dominant master event while recording, a further downstream update will be sent to all other connected peers with the new master event identifier for comparison.

### Timeline and Timeline Messages

In some embodiments, with each video recording, a message-based timeline is also generated and appended to as the recording continues. There are various message types logged to the timeline that keep a timed record of all pertinent device activity and any relevant data that had taken place in the surrounding area during the recording. These message types are timeline data stream parameters identified by flags that may include one or more of the following:
START—opens each timeline with location with location and heading data among other status related information;
EVENT_ID_UPDATED—logged to timeline whenever a new dominant masterEventID is received;
STATUS—reports on the location, heading status as well as basic peer related data and eventID assignments;
END—reports the closing status of the vantage when the recording stops;
CHECKSUM_GENERATED—reports a verification hash string generated from a finalized media artefact;
LOCATION CHANGE—logged with every pertinent location change;
ORIENTATION_CHANGE—reports orientation changes including landscape/portrait and front/back camera toggling;
READING_CHANGE—reports heading changes;
CAMERA_STATUS—reports the status of the camera in use, which can include which camera or lens is in use if multiple cameras/lenses are available, camera specs (e.g., sensor type, size) and camera settings such as aperture, shutter speed, ISO, etc.;
CAMERA_TOGGLE—reports the nature of a camera toggle on devices with multiple cameras (e.g., switching from main back camera on a smart phone to a user-facing camera);
SNAPSHOT_CAPTURED—logged whenever a picture is taken;
LIVE_MESSAGE_SENT—indicating a user generated message being sent out by the vantage recorder. May include anything from text in the message thread to animated AR flares in the surrounding area;
LIVE_MESSAGE_RECEIVED—logged when a message is detected in the recording network or from live viewers;
RETRO_MESSAGE—logged against a relative time stamp when an on-demand viewer adds to the thread at a particular point in the ViiVid ® playback;
PEER_LOCATION_CHANGE—logged whenever a peer changes location with the peer's initial event identifier;
PEER_ORIENTATION_CHANGE—reports a peer's orientation changes including landscape/portrait and front/back camera toggling;
PEER_HEADING_CHANGE—reports a peer's heading changes;
PEER_SNAPSHOT_TAKEN—logged whenever a connected peer takes a photo;
PEER_STATUS_RECEIVED—logged when a periodic status message is received from connected peer;
PEER_CHECKSU_M RECEIVED—logged when a verification hash string is received from a connected peer corresponding to media artefact;
PEER_CAMERA_STATUS—reports the status of a peer's camera (see CAMERA_STATUS);
PEER_CAMERA_TOGGLE—reports the nature of a camera toggle action on a connected peer's device;
PEER_ADD—reports when a new peer has been detected and added to the anchor/sibling lists; and
PEER_REMOVE—report when a peer finishes recording or contact has been lost with a peer.

In association with the event identifiers captured, the timeline plays a key role in determining how the vantages are combined, synchronized and rendered for the retrospective viewers. The timeline data is stored in a timeline artefact file and/or stored within the memory buffers.

### Graphical User Interface

The user interface may comprise user controls, a camera view with a possibly togglable augmented reality overlay. It may also feature a collapsible map view detailing the local area and a collapsible carousel previewing other vantages. The camera view's augmented reality overlay indicates the direction and relative distance between the current and available vantage points. The map view provides a representation of the local area with augmented reality location markers for POIs and other available vantage points. User gestures or user controls can be used to navigate between vantages or interact with POIs to perform other actions including previewing, messaging or information requests. In some implementations, users may view multiple vantages at once in a grid-like manner, with a picture-in-picture interface or across a multi-screen setup.

### AR Rendering

The data received by a device is preferably parsed in real-time for the rendering of vantage point AR markers, indicating the direction as well as distance and altitude of POIs, relative to the field of vision on a display screen. These markers can take the form of varying 3D shapes and may indicate what type of POI is being highlighted (e.g., locations of friends, 360° panoramic vantages, landmarks, local facilities, dining areas, etc.). Where a POI is outside of the bounds of the video frame (or the derived visible 3D frustum), peripheral markers or directional icons may indicate the relative position (distance, azimuth and altitude).

This offers the user a greater appreciation of space being viewed and the relative distances between vantage points while providing a more intuitive viewing and recording experience. While viewing or recording the ViiVid ®, virtual flares can be shot into the augmented reality rendition in order to attract the attention of other viewers to a position in the viewing area. These flares can take varied forms including text, images, captured stills and/or mini animations and may even be used as marketing space by third party companies or by users to tag objects/POIs/people within the footage. In some embodiments these tags can be shared in real time or retrospectively with friends or followers in a social network via communication mediums including social network applications, SMS, email, etc.

### Point of Interest Navigation

This technology is designed to give the user the most immersive experience as possible to create a sense of actually being at the event as opposed to simply seeing it from differing angles. As such, it may also be adapted and optimized for Virtual Reality (VR) experiences through the use of wearable tech including VR headsets, watches, glasses, gloves, sensors, headphones, etc. Other non-VR embodiments may include personal computers, handheld devices, televisions, smart devices and other multimedia devices with user interactive controls.

Responding to directional gestures or other user controls, some embodiments implement animations when switching vantages to give the impression of movement within the space (e.g., zoom, fade, 3D modelling, etc.). Taking into account the heading and orientation of non-360° panoramic camera feeds, user navigation may also be determined based on what the viewer wishes to see as opposed to where they want to see something from, e.g., a user who is interested in getting a closer view of a performance may not wish to switch to a front row vantage point that is filming a selfie video as the result would be looking towards the back despite being closer to the intended target.

In some embodiments, the acceleration, start/finish positions and route of the directional user gestures may determine the velocity and acceleration of the transition as well as the distance and/or direction in which they travel in, with the animation transition being adjusted to reflect this. Three-dimensional sound and haptic feedback (somatosensory communication) from the user's device may also be used to enhance the sensory experience of the user when viewing ViiVids through wearables, controllers, and mid-air haptics, all the way up to high-end exoskeletons and full-body suits.

Collapsible map views and vantage carousels both give the user a sense of the surrounding area and the POIs within it. They can both also be used as navigation controllers, allowing the user to interact with (including previewing, viewing, querying, etc.) the other POIs, whether or not they are inside the visible frustum, without shifting the recorded perspective. The moveable mini-view presents the user's current perspective when switched to another VP or renders the previewed perspective when previewing.

The navigation sequencing that is determined by the viewer can also be decided/suggested programmatically (using AI to discover the best or most popular vantages) or by a 3rd party like a producer. Navigable positions are not predetermined but calculated in real time (even with vantages entering and exiting the recording area), as the timeline information is parsed.

### Stop Recording

Preferably, when the recording concludes, all connections are closed and the device terminates its service advertisement in the surrounding area. The initialEventID and masterEventID are then reset to null while the siblings and anchors collections are emptied. Lastly, the local media and timeline artefacts are compressed then encrypted at rest and at the earliest opportunity uploaded for further server side processing, merging and redistribution, via an encrypted transmission.

### Trusted and Untrusted Artefacts

To enhance the interoperability and veracity of user-generated content, the notion of trusted/untrusted artefacts may be introduced to give the end user greater confidence that the content they are consuming has not been doctored since the time of recording. In some embodiments, content is categorized as “trusted,” “standard” and “untrusted.” Further categories or a quality grading/rating system (e.g., rated 1-5*) may be used in other embodiments. While “untrusted” vantages may still be included within the wider ViiVid ®, the viewer may be able to differentiate between different categories/ratings of vantages and in some implementations filter out one or more categories of vantages from the overall experience, based on this parameter.

In some embodiments, following the end of a recording, checksums may be generated for the local media and timeline artefacts that are then registered by both the server and local client. In some embodiments, peer devices may also register the checksums of other peer devices, creating a P2P network register so that vantages can be “verified” by other peer devices. The checksums are used in post-production to ensure the resultant vantage that reaches the server has not been amended, adding an extra layer of security and interoperability.

“Trusted” artefacts may include footage meeting two verifications: i) having verified checksums and ii) being provided by verified providers, e.g., official recording devices at an event (e.g., identifiable by a MAC address, serial number, location and/or position and/or a data stream parameter), or peer devices known to provide high quality footage (e.g., a highly-rated user or a device having characteristics such as being a high-grade camera).

“Untrusted” artefacts may include footage provided by poorly-rated users, from unverified sources and/or with data anomalies, such as mismatching checksums or unverifiable/conflicting/missing data (e.g., metadata or data stream parameter). For example, content might be considered “untrusted” if the vantage cannot be verified within the network of other vantages at the time of recording or subsequently (e.g., cannot be synchronized). Vantages manually added to a ViiVid ®, even if synchronized successfully (having matching checksums and thus “verified”), may be considered untrusted if the recording device did not synchronize/register itself in the timeline artefacts generated by other peer devices at the time of recording.

“Standard” artefacts may include footage having verified checksums but that is provided by standard users, or more generally footage not falling into the trusted/untrusted categories.

The server or recording device may maintain a trusted version of the vantage whether it be in the form of the media artefact of a reduced quality media artefact compiled by the server from a live stream.

### Server-Side Processing

The purpose of the server-side processing is to compile the individual videos, audio, stills and timeline artefacts into one multi-vantage video (or ViiVid ®) that can be consumed repeatedly. As such, the system preferably processes P2P heartbeats, visual/audio cues and many location and position updates throughout the feeds to provide a greater degree of accuracy, as video time signatures alone can be skewed depending on differing Network Time Protocol (NTP) time sources and NTP stratums. By using the timelines and event identification management algorithm described above, we essentially allow the content to contextualize itself, within time and space, relative to the other anchored content where possible. The vantage timelines are preferably merged and de-duplicated to form one master timeline for the ViiVid®, which provides a shared record of activity in the surrounding area to supplement the individual timelines.

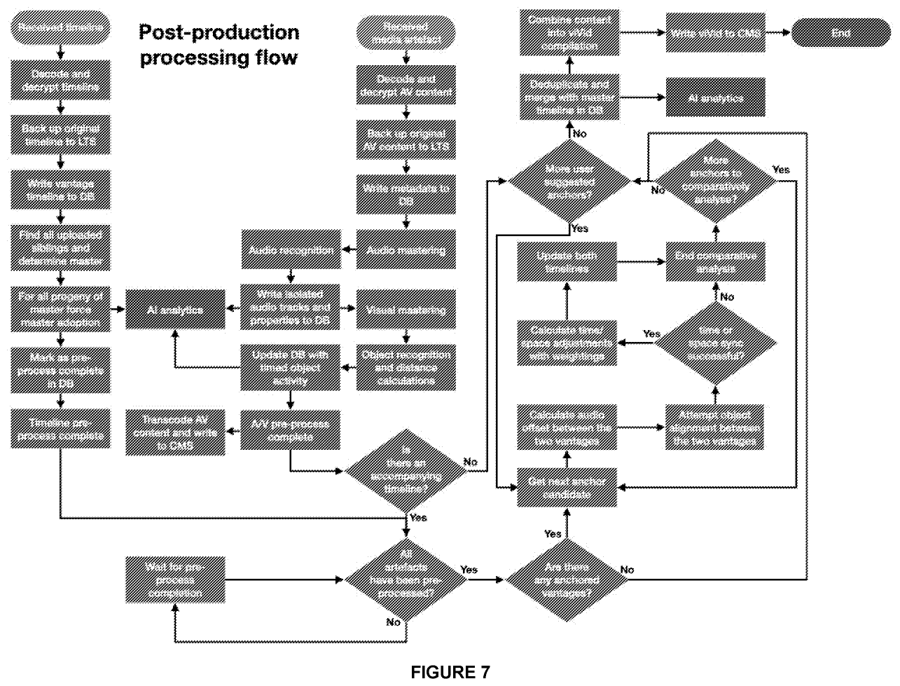

FIG. 7 illustrates the post-production processing flow in more detail, where the following acronyms are used: AI—Artificial Intelligence, AV—Audio/Visual, CMS—Content Management System, DB—Database, LTS—Long-term storage.

Each media artefact is decoded then processed by isolating the audio tracks in the video and aligning them with that of other anchor videos to determine the time offset between its start time and that of all its anchors. This offers greater timing synchronization accuracy that is not predicated on device-based time syncing (NTP) alone. In some embodiments, visual object recognition processing may be used to generate visual timing cues throughout the media footage. These cues may then be used to synchronize media artefacts by calculating timing offsets, particularly when the audio data is missing, unclear or unreliable. This timing information is then used to make adjustments on the master timeline for more accurate vantage start times such that the master maintains the single source of best truth.

As well as videos, other media formats such as captured still images and audio may also be woven into the ViiVid ®. Examples of this may include the output from a directional microphone centered on a performance being used as an enhanced audio overlay for lower quality video vantages, or an image featuring at a specific point in the footage as a temporary AR marker in the position it was captured and/or the featuring in the carousel.

Other post-production techniques including image and audio mastering may also be performed at this stage. The audio may be processed using equalization, compression, limiting, level adjustment, noise reduction and other restorative and/or enhancement processes while the visual mastering techniques may include color correction, motion stabilization, audio-visual alignment, wide angle distortion correction and other mastering techniques where required.

Automatic and/or recommended vantage switching sequences may also be determined by artificial intelligence utilized as part of post-production processing. An example of this may be determining which vantage point to switch to upon the conclusion of a vantage, such that the viewer experiences the least disruption.

More sophisticated visual processing (visual object recognition algorithms, temporal parallax methods and some geometry) may also be performed to better calculate the distance between vantage points (relative position) by triangulating between multiple points of interest (POIs) within a shared field of view. This provides a greater degree of accuracy when plotting vantage point locations and movements. For example, vantage A is “x” meters away from the lead singer on stage and “y” meters behind another concert attendee with a striking red hat. Using this information, vantage B, an anchor of vantage A, is able to better calculate its distance from vantage A by calculating its distance to those same points of interest and triangulating the position of vantage A. Any pertinent location alterations as a result of such visual processing are also reflected in the master timeline.

In some embodiments, geolocation and triangulation may be used, e.g., using inbuilt GPS sensors and mobile network/WI-FI®/BLUETOOTH® triangulation. As 5G technology takes hold, this will provide increased bandwidth and reduced latency, further enhancing reliability. In further embodiments, device detection may be used. Some devices comprise cameras with laser focus or depth perception elements and these can be used to more accurately measure relative distances to devices and the environment. Peer devices may also be able to detect one another using their inbuilt cameras—many devices have front and rear cameras and these can be utilized to capture additional photographs of the environment and be analyzed to identify other devices in the network and their relative position.

In some embodiments, individual audio tracks within a ViiVid ® may be identified and isolated for further processing enabling music discovery, user controlled levelling and/or greater user insights. For example, a viewer may wish to decrease the volume of the ambient noise, while increasing the volume of the brass sections of the band being captured in the ViiVid ® they are watching. Audio recognition techniques may also be employed to determine user interests, informing them of where they can purchase the music they are listening to or suggesting similar content to consume.

In some embodiments, the object recognition algorithms could be used to auto-tag inanimate objects for purchasing suggestions (based on user preferences) and may even provide affiliate links to the vendors of such items. Furthermore, users may manually tag objects for purchasing or even add these items on to a wish list.

With these processing methods, users are also able to retrospectively recommend other non-anchored vantages (e.g., videos, images audio extracts, etc.) for merging with the rest of the ViiVid ® using the audio and visual cues. The same audio isolation, object recognition and temporal parallax algorithms will be run on those vantages in an attempt to synchronize and contextualize it within a time and space relative to the other vantages.

This processing can be achieved by leveraging cloud based resources such as compute nodes, storage (including long-term storage; LTS), content management systems (CMS), structured and unstructured databases (DB), content delivery networks (CDN) with end node caching, web containers, etc. As a result, the encoding, transcoding, multiplexing and post-processing can automatically be performed server-side before serving the content to any client capable of rendering the footage.

A fully exportable ViiVid ® media artefact can then be generated and replayed retrospectively, on or offline, on compatible players. This media format may comprise all available media feeds or a selected subset of the vantages for user consumption.

FIG. 7 illustrates an example of a post-production workflow used to automatically process and merge AV and timeline artefacts into the ViiVid ® media format.

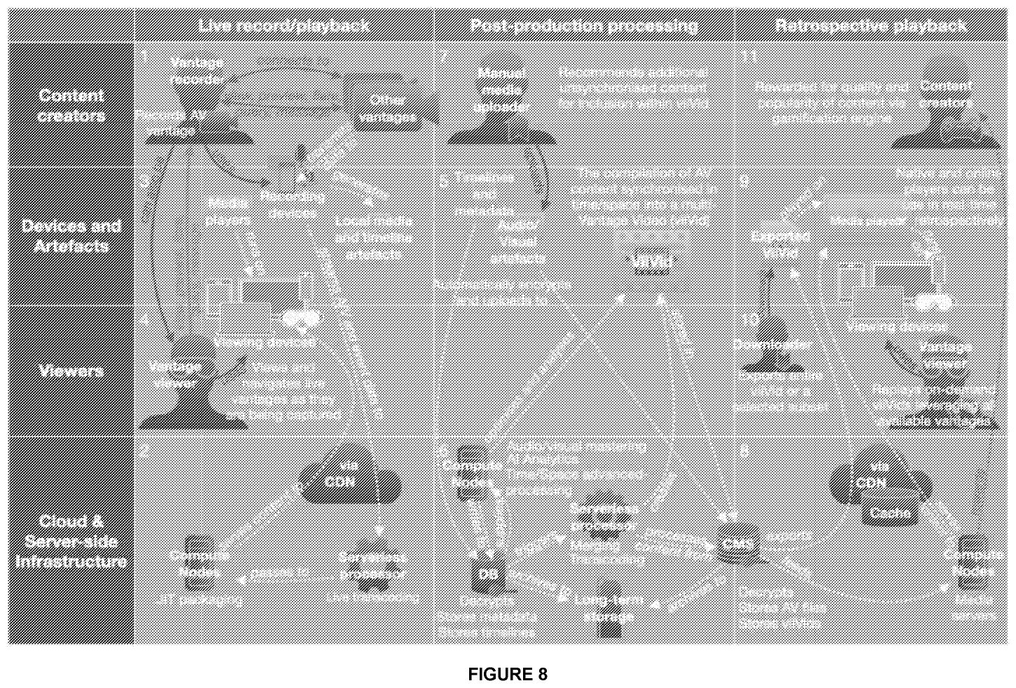

FIG. 8 illustrates an example end-to-end workflow detailing key actors and processes involved from the live recording vantage panning phase through to server side processing, ending with the retrospective playback.

### Retrospective ViiVid ® Panning

Pre-recorded or compiled ViiVids may be consumed on or offline through web, mobile and local clients (player applications). Such players may include embeddable media player, a web-based html plugin, application programming interface (API), cross platform mobile clients, etc.

In some embodiments, when a ViiVid ® is replayed back, the associated timeline (and/or master timeline) is in effect replayed alongside the vantage being consumed. Preferably, a compatible player will store a number of variables that pertain to the recording network at the time the footage was captured. These variable may include:
the current location;
the current position;
detailed collection of anchors where each anchor includes:
   the offset (when the anchor vantage begins relative to the current recording);
   the anchor's location;
   the anchor's position; and
   a collection of anchors.

Along with some other activities, these variables notably determine when and where in the playback to render (AR/VR) POI markers and how to animate the vantage switching when the user performs a directional navigation gesture. When viewing the ViiVid ®, all available vantages are determined by that vantage's anchors and their offsets, which can be negative or positive depending on which video began first.

As the recording replays, the timeline events are read from the timeline sequentially and interpreted by altering these same variables, which, in some instances, invoke downstream rendering changes, thus the displaying/rendering of the data stream can be dependent on particular timeline variables, e.g., dependent on system or user preferences. At the time a LOCATION_CHANGE, ORIENTATION_CHANGE or READING_CHANGE flag is read from the timeline, the relative positions of all rendered POIs is adjusted as appropriate. Likewise, when a PEER_LOCATION_CHANGE, PEER_ORIENTATION_CHANGE or PEER_HEADING_CHANGE flag is read, the peer in question will have the respective location of its POI marker adjusted.

The ORIENTATION_CHANGE flag may also instruct the player when to toggle between portrait and landscape mode during the playback as well acute angled orientation transitions. SNAPHOT flags inform the player of when a picture was taken in the surrounding area, which may then also be replayed over the playback.

Preferably, when a vantage switch is performed, the current video stops or fades out and new video resumes, fading in at the same relative position calculated by the sum of the offset and the stop position of the old video. In this way, we are able to achieve a continuous audio stream even when navigating vantages. Moreover, during these navigations, the variable values determine how best to move over the viewing area such that the position and heading are altered with one seamless transition, simulating the effect of physical movement. Part of the synchronization process may involve analyzing these various timeline flags and prioritizing particular vantages based on their timelines, e.g., dependent on system or user preferences.

In some embodiments, compatible players may simultaneously play all or some anchored vantages in the background, bringing requested anchors to the foreground when a user switches to, or previews that vantage. In this way, the player is able to improve the performance of the transitions by ensuring the desired anchored vantage is ready and waiting (in low latency RAM) the very instance it is requested from the user, as opposed to waiting for a response from a server or higher latency memory modules.

To improve the network and processing efficiency of the ViiVid ® replays, these background vantages may also be played at a lower bitrate and/or resolution until they are called into the foreground, e.g., utilizing server-side transcoding.

### Retrospective ViiVid ® Editing

In some embodiments, a ViiVid ® editor may be used, enabling a user to select their preferred vantage navigation sequence or to isolate a subset of vantages in one ViiVid ® or video compilation artefact. The editor may also provide vantage editing capabilities, similar to video editing applications. By using the editor, the resultant artefacts may be exported, consumed and shared but may (at least initially) be considered “untrusted” on account of them failing their initial checksums.

In some embodiments, vantages related by location, but not necessarily time, may be merged together in order to create a four-dimensional ViiVid ® virtual tour (3D-space×time) of the area within which the vantages were captured.

### Use Cases

There are many real world applications of this technology where events are being captured with a combination of 360° and/or traditional video recording devices. Some uses include:
Newly wedded couples seeking to combine all user captured and/or professionally taken video footage of their wedding in order to relive their first dance or the entrance of the bride while traversing the many vantages;
A sporting event where an attendee may wish to pan to view an alternative perspective from where they are physically located;
A concert promoter wishing to harnessing virtual reality headsets to sell virtual tickets for a live musical event to individuals that are unable to physically attend;
An evidential system used by a security agency to combine all available footage from an event as part of an investigation.

When used in this specification and claims, the terms “comprises” and “comprising” and variations thereof mean that the specified features, steps or integers are included. The terms are not to be interpreted to exclude the presence of other features, steps or components.

Any of the various features disclosed in the foregoing description, claims and accompanying drawings may be isolated and selectively combined with any other features disclosed herein for realizing the disclosure in diverse forms.

Although certain example embodiments of the disclosure have been described, the scope of the appended claims is not intended to be limited solely to these embodiments. The claims are to be construed literally, purposively, and/or to encompass equivalents.

### Non-Limiting Examples of the Disclosure

Example 1. A computer-implemented method for synchronizing data streams, comprising: using a first device, generating a first data stream comprising audio and/or video; advertising the first data stream on a network; receiving a second data stream comprising audio and/or video via the network; and maintaining a status of the data streams over the network for synchronizing the data streams.

Example 2. A computer-implemented method for synchronizing data streams, comprising: generating or receiving a first data stream comprising audio and/or video; advertising the first data stream on a network; generating or receiving a second data stream comprising audio and/or video; advertising the second data stream on the network; and maintaining a status of the data streams over the network for synchronizing the data streams.

Example 3. The method according to any of Examples 1 or 2, further comprising: generating or receiving an event timeline for the first and/or second data streams; and/or receiving the status of the second data stream over the network for synchronizing the data streams; and/or synchronizing the data streams; and/or combining the first and second data streams into a consolidated data stream.

Example 4. The method according to any of Examples 1 through 3, wherein the network comprises WI-FI®, BLUETOOTH® and/or cellular network technologies.

Example 5. The method according to any of Examples 1 through 4, wherein: the first data stream comprising audio and/or video has a first identifier and is generated by a first device having a first vantage point of an event; the second data stream comprising audio and/or video has a second identifier and is generated by a second device having a second vantage point of an event; and the network comprises a P2P network.

Example 6. The method according to any of Examples 1 through 5, wherein maintaining a status of the data streams on the network comprises: sending and/or receiving and/or analyzing an event timeline for the first and/or second data streams; and/or sending and/or receiving data between the devices and/or a server, the data comprising one or more of: P2P handshakes, NTP data, timing heartbeats and parameters of the data stream(s); and/or the or each device monitoring and sending and/or receiving data relating to changes to one or more parameters of the data stream(s); and/or the or each device detecting other data streams being advertised on the network.

Example 7. The method according to any of Examples 1 through 6, further comprising: assigning an identifier based on: a video start time, a device ID and/or a device location, preferably wherein: the identifier comprises an initialEventID and a masterEventID and the method comprises comparing and updating the initialEventID and/or the masterEventID amongst devices on the network; and/or the or each identifier comprises one or more of: metadata, time, device ID, device location and device position data.

Example 8. The method according to any of Examples 1 through 7, wherein the method further comprises: synchronizing and/or combining the data streams substantially in real time; and/or synchronizing the data streams based on corresponding time, location and/or position, within a predefined range; and/or adjusting a bitrate of the data stream(s) depending on a connection speed and/or latency; and/or tracking parameters of the data streams, preferably in real time; and/or ranking the data streams based on parameters of the data streams.

Example 9. The method according to any of Examples 1 through 8, further comprising: analyzing the data streams for duplicate audio content and editing the consolidated data stream to provide a single audio track for the consolidated data stream; and/or analyzing and editing the data streams to provide a consolidated field of view for the consolidated data stream; and/or merging data streams to provide the consolidated data stream.

Example 10. The method according to any of Examples 1 through 9, further comprising: displaying or rendering both the first and second data streams on the first and/or second device(s) and/or a third device; and/or sending the first and/or second data stream to a user and indicating available data streams to the user; and/or mapping vantage points of available data streams on a map, preferably in real time; and/or displaying the data stream to a user and providing controls for navigating between vantage points of available data streams, preferably further comprising animating transitions between vantage points; and/or receiving and processing input gestures from the user for navigating between vantage points.

Example 11. The method according to any of Examples 1 through 10, wherein: the first data stream comprising audio and/or video has a first identifier and is generated by a first device having a first vantage point of an event; the second data stream comprising audio and/or video has a second identifier and is generated by a second device having a second vantage point of an event; the network comprises a P2P network; and maintaining a status of the data streams comprises: sending and/or receiving data between the devices and/or a server, the data comprising P2P handshakes and parameters of the data stream including the location and/or position of the devices; and the method further comprises: synchronizing the data streams based on corresponding time and location data, substantially in real time.

Example 12. The method according to any of Examples 1 through 11, comprising: sending and/or receiving event timelines for the first and second data streams, the event timelines comprising time and location data; synchronizing the data streams substantially in real time; displaying both the first and second data streams on the first and/or second device(s) and/or a third device; indicating available data streams to the user on the display; and receiving and processing user input for navigating between the available data streams.

Example 13. A compute node or server configured to: receive a first data stream comprising audio and/or video; advertise the first data stream on a network; receive a second data stream comprising audio and/or video; advertise the second data stream on the network; and maintain a status of the data streams over the network.

Example 14. The server according to Example 13, further configured to: synchronize the data streams; and/or combine the data streams into a consolidated data stream.

Example 15. The method or server according to any of Examples 13 and 14, wherein: the advertising of the data streams occurs substantially in real-time; and/or the status of the data streams on the network is maintained substantially in real-time.

Example 16. The method according to any of Examples 1 through 12, the server according to any of Examples 13 through 15, further comprising: analyzing parameters of the data streams and allocating data processing tasks to the devices on the network based on the data stream parameters; and/or determining and then transmitting data via the shortest route to a destination through the network, preferably using the Open Shortest Path First (OSPF) protocol.

Example 17. The method according to any of Examples 1 through 12, the server according to any of Examples 13 through 15, wherein the consolidated data stream comprises a multi-vantage-point video comprising at least alternative primary and secondary video footage of an event from multiple different vantage points, wherein the vantage point for at least a portion of the video is user-selectable.

Example 18. The method according to any of Examples 1 through 12, the server according to any of Examples 13 through 15, wherein the consolidated data stream comprises a multi-vantage-point video comprising: video frames stitched from image or video frames from multiple vantage points; and/or audio stitched from multiple different vantage points.

Example 19. The method according to any of Examples 1 through 12, the server according to any of Examples 13 through 15, wherein the available vantage points for the consolidated data stream: change dynamically depending on parameters of the data stream and/or are determined substantially in real-time based on the availability of the data streams.

Example 20. The method or server according to any of Examples 1 through 19, further configured to: perform visual processing to remove anomalies or obstructions in the field of vision; and/or perform visual processing to calculate relative positions of vantage points using object recognition and/or points of interest in the field of vision, calculate a timing offset between data streams and/or simulate an alternative vantage point; and/or perform audio processing to consolidate audio data, calculate a timing offset between data streams, remove background noise and/or simulate an alternative vantage point; and/or export the consolidated data stream to a computer-readable media format.

Example 21. The method or server according to any of Examples 1 through 20, further comprising: weighting the data streams depending on one or more of: recording start time, audio or video data parameters, data stream bit rate, field of view, location and position; and/or transcoding the data stream for delivery to an end user's device; and/or maintaining a database of data streams and consolidating the data streams with other data, preferably pre-recorded image/video/audio footage and/or live recordings from external sources; and/or generating or rendering an augmented or virtual reality viewer comprising the first, second and/or consolidated data stream(s) and a graphical overlay indicating a direction and/or relative distance between the current and available vantage viewpoints and/or additional points of interest.

Example 22. A device or a network of devices configured to perform the method according to any of Examples 1 through 21.

Example 23. A computer-readable medium comprising instructions that, when executed: perform the method according to any of Examples 1 through 22, and/or display or render the consolidated data stream according to any of Examples 3 through 22.

Example 24. A computer-readable file format providing the consolidated data stream according to any of Examples 3 through 23.

Example 25. A media format comprising video, wherein a vantage point of the video is user-selectable.

1. A computer-implemented method for synchronizing data streams, comprising:
generating, or receiving, a first data stream comprising at least one of audio or video from a first vantage point of an event;
generating, or receiving via a network, a second data stream comprising at least one of audio or video from a second vantage point of the event;
maintaining a status of the data streams over the network for synchronizing the data streams, comprising logging START and END data stream parameters for each data stream, indicating start and end timings for each data stream;
synchronizing the data streams; and
generating a master event timeline for the data streams, the master event timeline comprising the start and end timings for each data stream, for a user to select an available data stream.

2. The computer-implemented method for synchronizing data streams of claim 1, comprising:
using a first device, generating a first data stream comprising at least one of audio or video from a first vantage point of an event;
advertising the first data stream on a network;
receiving a second data stream comprising at least one of audio or video from a second vantage point of the event, via the network;
maintaining a status of the data streams over the network for synchronizing the data streams, comprising logging START and END data stream parameters for each data stream, indicating the start and end timings for each data stream;
synchronizing the data streams; and
generating a master event timeline for the data streams, the master event timeline comprising the start and end timings for each data stream, for a user to select an available data stream.

3. The method of claim 1, further comprising:
indicating available data streams to a user for selection, based on START and END data stream parameters for each data stream;
receiving and processing user input for selecting an available data stream; and
sending, displaying or rendering the selected data stream to the user.

4. The method of claim 1, further comprising:
combining the first and second data streams into a consolidated data stream.

5. The method of claim 1, wherein maintaining a status of the data streams over the network further comprises logging at least one location or position data stream parameters for each data stream; and the method further comprises synchronizing the data streams based on the data stream parameters.

6. The method of claim 1, further comprising receiving and processing user input indicating an intended direction of travel to another vantage point; and
sending, displaying or rendering the corresponding data stream to the user.

7. The method of claim 1, wherein:
the first data stream has a first identifier and is generated by a first device having a first vantage point of an event;
the second data stream has a second identifier and is generated by a second device having a second vantage point of the event; and
the network comprises a P2P network.

8. The method of claim 1, wherein maintaining a status of the first or second data streams on the network comprises one or more of:
at least one of sending or receiving an event timeline for at least one of the first or second data streams;
at least one of sending and receiving data between at least one of the first or second devices or a server, the data comprising one or more of: P2P handshakes, NTP data, timing heartbeats or parameters of the first or second data stream(s);
a device monitoring and at least one of sending or receiving data relating to changes to one or more parameters of the first or second data stream(s); or
a device detecting other data streams being advertised on the network.

9. The method of claim 1, further comprising:
assigning an identifier based on at least one of: a video start time, a device ID or a device location, wherein at least one of:
the identifier comprises an initialEventID and a masterEventID and the method comprises comparing and updating the initialEventID or the masterEventID amongst devices on the network; or
the identifier comprises one or more of: metadata, time, device ID, device location or device position data.

10. The method of claim 1, further comprising one or more of:
at least one of synchronizing or combining the data streams substantially in real time;
synchronizing the data streams based on at least one of corresponding time, location or position, within a predefined range;
adjusting a bitrate of the data stream(s) depending on at least one of a connection speed or latency;
tracking parameters of the data streams in real time;
ranking the data streams based on parameters of the data streams;
analyzing the data streams for duplicate audio content and editing the consolidated data stream to provide a single audio track for the consolidated data stream;
analyzing and editing the data streams to provide a consolidated field of view for the consolidated data stream;
merging data streams to provide the consolidated data stream;
at least one of displaying or rendering the first and second data streams on at least one of a first device, a second device, or a third device;
mapping vantage points of available data streams on a map in real time;
providing controls for navigating between vantage points of available data streams;
animating transitions between vantage points; or
receiving and processing input gestures from the user for navigating between vantage points.

11. (canceled)

12. (canceled)

13. The method of claim 6, wherein maintaining a status of the data streams comprises:
at least one of sending or receiving data between at least one device or a server, the data comprising P2P handshakes and parameters of the data streams including at least one of a location or a position of the at least one device; and
the method further comprises:
synchronizing the data streams based on corresponding time and location data, substantially in real time.

14. The method of claim 13, comprising:
at least one of sending or receiving event timelines for the first and second data streams, the event timelines comprising time and location data; and
displaying the first and second data streams on at least one of a first device, a second device, or a third device.

15. A compute node, device or server configured to:
generate or receive a first data stream comprising at least one of audio or video from a first vantage point of an event;
generate or receive a second data stream comprising at least one of audio or video from a second vantage point of the event, via a network;
maintain a status of the first and second data streams over the network, comprising logging START and END data stream parameters for each data stream, indicating start and end timings for each data stream;
synchronize the data streams; and
generate a master event timeline for the data streams, the master event timeline comprising the start and end timings for each data stream, for a user to select an available data stream.

16. (canceled)

17. The method of claim 1, wherein:
advertising of the data streams occurs substantially in real time; or
the status of the data streams on the network is maintained substantially in real time.

18. The method of claim 1, further comprising at least one of:
analyzing parameters of the data streams and allocating data processing tasks to devices on the network based on the data stream parameters; or
determining and then transmitting data via the shortest route to a destination through the network.

19. The method of claim 4, wherein the consolidated data stream comprises at least one of:
a multi-vantage-point video comprising at least alternative primary and secondary video footage of an event from multiple different vantage points, wherein the multi-vantage point for at least a portion of the multi-vantage-point video is user-selectable; or
a multi-vantage-point video comprising at least one of:
video frames stitched from image or video frames from multiple vantage points; or
audio stitched from multiple different vantage points; or
wherein available vantage points for the consolidated data stream:
change dynamically depending on parameters of the consolidated data stream; or
are determined substantially in real-time based on availability of the data streams.

20. (canceled)

21. (canceled)

22. The method of claim 1, further configured to at least one of:
perform visual processing to remove at least one of anomalies or obstructions in a field of vision;
perform visual processing to calculate relative positions of vantage points using at least one of object recognition or points of interest in the field of vision, and then at least one of calculate a timing offset between data streams or simulate an alternative vantage point;
perform audio processing to consolidate audio data;
calculate a timing offset between data streams;
remove background noise or simulate an alternative vantage point; or
export a consolidated data stream to a computer-readable media format.

23. The method of claim 1, further comprising at least one of:
weighting the data streams depending on one or more of: recording start time, audio or video data parameters, data stream bit rate, field of view, location and position;
transcoding the data streams for delivery to an end user's device;
maintaining a database of data streams and consolidating the data streams with other data; and
generating or rendering an augmented or virtual reality viewer comprising at least one of a first, a second or consolidated data stream(s) and a graphical overlay indicating at least one of a direction or relative distance between current and available vantage viewpoints or additional points of interest.

24. The method of claim 1, further comprising:
generating checksums for a first data stream, a second data stream and any additional data streams;
verifying the checksums; and
categorizing the data streams based on the verification.

25. (canceled)

26. A non-transient computer-readable medium comprising program instructions that, when executed by a computer including a processor:
cause the computer to perform the method of claim 1.
